(19) United States
(12) Patent Application Publication
(10) Pub. No.: US 2016/0311147 A1
(43) Pub. Date: Oct. 27, 2016

(54) EXTRUSION DIE FOR TAPE ELEMENTS CONTAINING CRACK PROPAGATION CHANNELS

(71) Applicant: Milliken & Company, Spartanburg, SC (US)

(72) Inventors: Padmakumar Puthillath, Greer, SC (US); Sujith Nair, Greer, SC (US); Charles W. Prestridge, LaGrange, GA (US); Johann Peschek, Gent (BE); Venkatkrishna Raghavendran, Greer, SC (US)

(21) Appl. No.: 15/019,688

(22) Filed: Feb. 9, 2016

Related U.S. Application Data
(60) Provisional application No. 62/151,115, filed on Apr. 22, 2015.

(51) Int. Cl. B29C 47/14; B29C 47/88; B29C 47/00

(52) U.S. Cl. CPC B29C 47/14; B29C 47/0021; B29C 47/884; B29C 47/8895; B29C 47/0069; B29C 47/0057; B29L 2030/00

(57) ABSTRACT

A tape element having at least a first layer containing a first thermoplastic polymer, at least one crack propagation channel in a surface of the tape, and at least one reciprocal channel in the opposite surface of the tape, where the channels in the two surfaces are in registration. The crack propagation channel has an aspect ratio of width to depth of between about 1:5 and 10:1, has a depth at least 10% of the thickness of the tape in the segments, and extend along at least a portion of the length of the tape. Rubber articles containing the tape element are also disclosed and a die to make the tape elements.

### RELATED APPLICATIONS

This application claims priority to provisional US patent application 62/151,115 filed on Apr. 22, 2015 which is herein incorporated in its entirety.

### FIELD OF THE INVENTION

The present invention generally relates to tape elements containing crack propagation channels and fiber reinforced rubber articles having tape elements containing crack propagation channels.

### BACKGROUND

Reinforced rubber goods are used in a wide variety of consumer and industrial applications. The performance of reinforced molded rubber goods depends on the adhesion of the reinforcement to the rubber. Fabrics made with synthetic yarns tend to be difficult to bond to rubber.

In practice several things are done to improve adhesion, most of them involving coating fibers and/or fabric with an adhesion promoter. For example, as the fibers are drawn a spin finish may be applied which may contain an adhesion activator such as an epoxy resin.

A typical passenger car radial tire has two steel belt packages configured at ±θ bias (θ can be roughly 21°). The steel belts are unequal in width and the result is a roughly ½″ wide step-change on either ends, as seen from the schematic above. This belt-edge being unconstrained, is the one of the highest strained channels and hence also the region that sees the largest operating temperature. Cap-ply provides restraining force to reduce the belt-edge flexure and this becomes more important at high speeds.

There remains a need for reinforced rubber articles having fibrous layers with enhanced adhesion due to geometry and other physical properties.

### BRIEF SUMMARY

A tape element having at least a first layer containing a first thermoplastic polymer, at least one crack propagation channel in a surface of the tape, and at least one reciprocal channel in the opposite surface of the tape, where the channels in the two surfaces are in registration. The crack propagation channel has an aspect ratio of width to depth of between about 1:5 and 10:1, has a depth at least 10% of the thickness of the tape in the segments, and extend along at least a portion of the length of the tape. Rubber articles containing the tape element are also disclosed.

### BRIEF DESCRIPTION OF THE DRAWINGS

FIG. 1 illustrates schematically a fibrous layer being a unidirectional fabric embedded in rubber.

FIG. 2 is a cutaway partial view of a pneumatic radial tire.

FIG. 3 is a cross-section view of a pneumatic radial tire.

FIGS. 4 and 5 are illustrations of a reinforced rubber article being a hose.

FIG. 6 illustrates schematically one embodiment of an air spring containing tape elements

FIG. 7 illustrates schematically an embodiment of an exemplary tape element having one layer.

FIG. 8 illustrates schematically an enlargement of the cross-section of a tape element showing the depth and width of a crack propagation channel and a reciprocal channel.

FIG. 9 illustrates schematically a cross-section of a tape element having multiple crack propagation channels and reciprocal channels.

FIG. 10 is a micrograph of a cross-section of a tape element showing one crack propagation channel and one reciprocal channel.

FIG. 11 is a micrograph of a cross-section of a tape element showing multiple crack propagation channels and multiple reciprocal channels.

FIG. 12 is a micrograph of the top surface of a tape element showing multiple crack propagation channels.

FIGS. 13 and 14 are images of die openings.

FIG. 15 is an enlarge image of one elongated protrusion at the die opening.

### DETAILED DESCRIPTION

This invention includes a highly-drawn, high-tenacity tape element that has surface features that create distinct segments that are partially or wholly separated or are separable from its neighboring segments; the method of manufacturing the same and the die designs that create the desired product.

The segments are separated by boundaries that are different in cross-section preferably lower in cross-section compared to its neighbors called crack propagation channels.

The segmented construction of the tape elements with the crack propagation channels in-between segments essentially acts like a two-way hinge and provides the ability to flex in the transverse direction enabling a conforming configuration at the step change in between the steel-belts in a cured tire and other applications requiring conformity along the width of a tape element. The segmented tape construction with crack propagation channels enable good orientation of the polymer in the segments and hence maintains the high-modulus similar to that of the highly drawn monolithic tape geometry. The segmented tape is expected to maintain the good adhesion benefits seen with the tape geometry.

The channel and its features result in stress concentration when the segmented tape is loaded. The channels, hence act as lines of weakness and control the failure (crack) pathways in the full width of the wide tape.

The segmented wide tape has the top and bottom faces of segments parallel to each other—which implies no crimp.

The channels maintain the connectivity of the high-modulus segments in a segmented wide-tape and this implies uniform load sharing between the segments when the wide tape is loaded. This overcomes the non-uniform tension (or lengths) possible with a narrow woven construction. This implies uniform constraint force across the width of a tire and also a uniform tire stiffness.

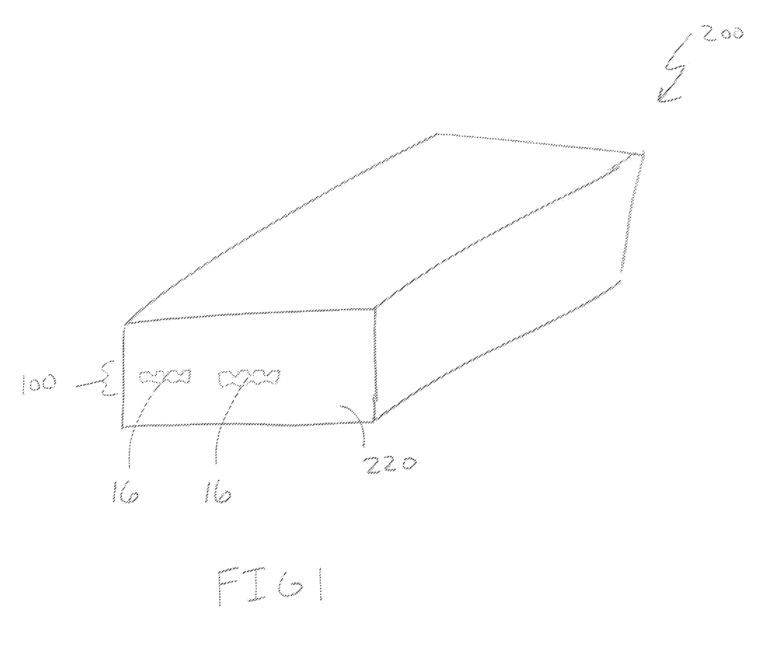

FIG. 1 illustrates a reinforced rubber article 200 containing a fibrous layer 100 embedded into rubber 220. The fibrous layer 100 contains a plurality of fibers 10. The reinforced rubber article 200 may be any rubber article reinforced with fibers, such as tires, belts, air springs, hoses, and the like.

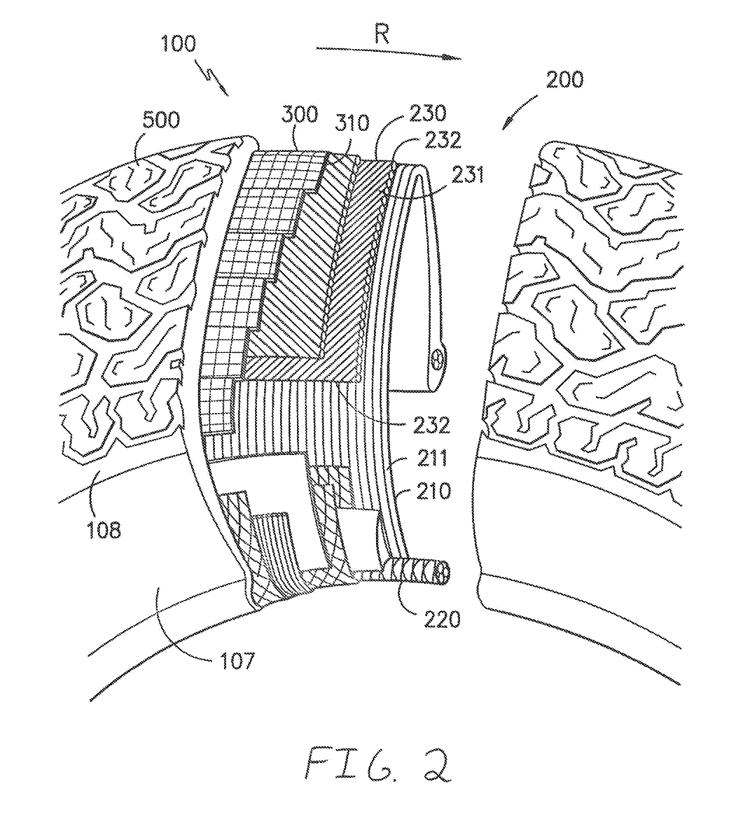

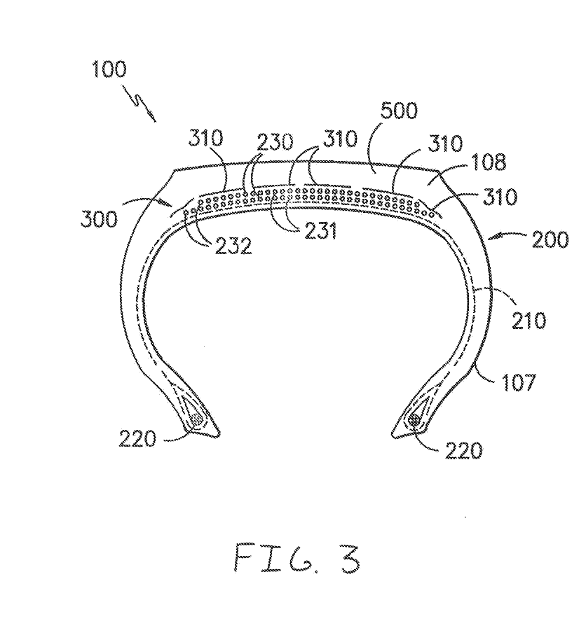

Referring now to FIGS. 2 and 3, there is shown one embodiment of a reinforced rubber article 200 being a tire, comprising side walls 107 joined to a tread 500 by shoulders. The tire 200 includes a carcass 210 covered by the tread 500. In FIG. 2, the tire 200 is a radial tire.

However, the present invention is not limited to radial tires and can also be used with other tire constructions. The carcass 210 is formed from one or more plies of tire cord 211 terminating at the inner periphery of the tire in metal beads 220, with at least one belt ply 334 located circumferentially around the tire cord 312 in the area of the tread 500. The carcass 210 is constructed so that the reinforcing cords 211 are running substantially radially of the intended direction of rotation R of the tire 200. The belt plies are formed with relatively inextensible warp materials, such as steel cord reinforcing warps, which run in the intended direction of rotation R of the tire or, more usually, at a slight angle thereto. The angle of the inextensible warp materials 331 can vary with the method of construction or application.

A cap ply layer 310 is located between the belt plies 232 and the tread 500. The cap ply layer 310 shown is formed from a cap ply tape 300 wound around the tire circumferentially in a flat helical pattern. Some suitable cap ply fabrics are described in U.S. Pat. Nos. 7,252,129, 7,614,436, and 7,931,062, each of which are incorporated herein by reference in their entirety.

Any fabric extending between the bead and the tread is defined herein as a “sidewall fabric” including chipper, flipper, and chafer fabrics. This includes fabrics that also extend around the bead to the inside of the tire such as a flipper fabric, as long as at least part of the fabric is located between the bead and the tread.

A tire carcass is required to have substantial strength in the radial direction running from bead to bead transverse to the direction rotation during use. To provide this strength, the fabric stabilizing material (also known as tire cord) has typically been a woven fabric with substantially inextensible pre-stressed high tenacity yarns running in the warp direction (also known as the “machine direction”) which are drawn and tensioned during the fabric formation and/or finishing process. This fabric is then cut in the cross-machine direction (i.e. transverse to the warp yarns). Individual pieces of the fabric are then rotated 90 degrees and are assembled to one another for placement in the carcass such that the high strength warp yarns are oriented in the desired radial direction between the beads. Thus, in the final construction, the weft yarns are oriented substantially circumferentially (i.e. in the direction of tire rotation.)

In another embodiment, the carcass stabilizing fabric is formed is a warp knit, weft inserted fabric having weft insertion yarns formed from the relatively inextensible reinforcing cords. Alternatively, the carcass stabilizing fabric may be a woven fabric having weft yarns formed from relatively inextensible reinforcing cords or a laid scrim. More information about this stabilizing having relatively inextensible reinforcing cords in the weft direction of the textile may be found in U.S. patent application Ser. No. 12/836,256 filed on Jul. 14, 2010, which is incorporated herein by reference in its entirety.

The fibrous layer 100 in the tire of FIGS. 2 and 3 (reinforced rubber article 200) may be a cap ply, carcass ply, chafer, flipper, clipper, body ply, shoulder ply, belt ply, belt separator ply, bead wrap, belt edge wrap, or any other fibrous layer within a tire.

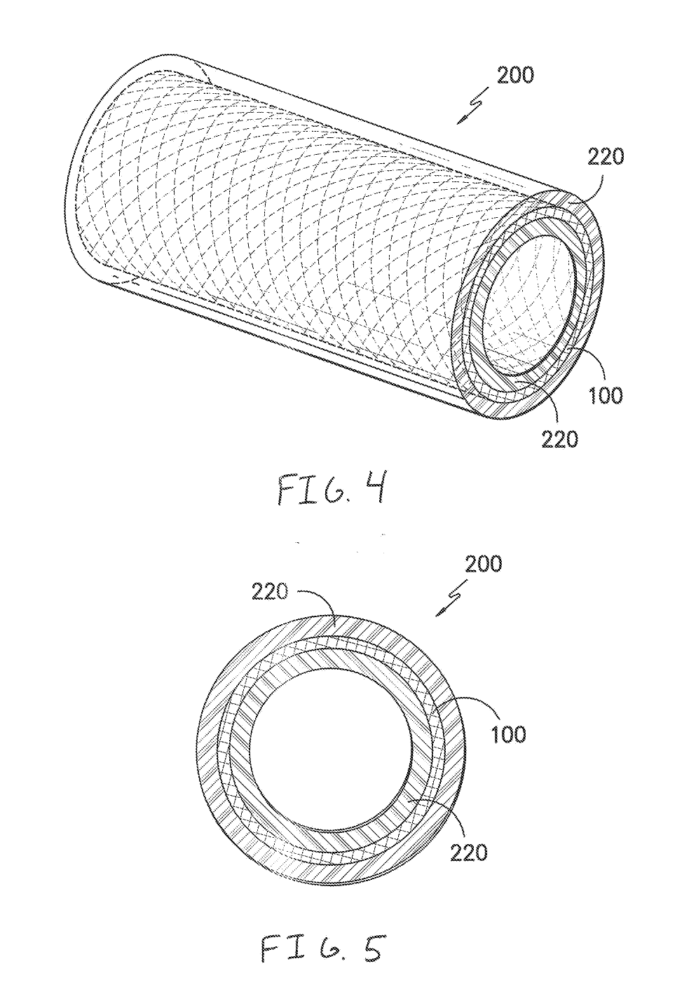

Referring now for FIGS. 4 and 5, there is shown a reinforced rubber article 200 in the form of a fabric reinforced hose. One of the most widespread and most suitable conventional hose is the so-called “mesh-reinforced” type, in which the fibrous layer 100 is formed by yarns spirally wound on the flexible hose forming two sets of yarns, the first in parallel and equidistant rows and superimposed on an equal number of transverse threads along likewise parallel and equidistant lines which are arranged symmetrically with respect to the axis of the tubular body of the hose so as to form a fabric “mesh” with diamond-shaped cells. Any other suitable fibrous layer 100 may also be used in hoses. The fibrous layer 100 is embedded into rubber 220. In addition to hoses, the fibers and fibrous layers may be used to reinforce any suitable rubber article including belts such as power transmission belts, printers blankets, and tubes.

Some other reinforced rubber products 200 include printer blankets and transmission belts. In offset lithography the usual function of a printing blanket is to transfer printing ink from a printing plate to an article such as paper being printed whereby the printing blanket comes into repeated contact with an associated printing plate and the paper being printed. Printer blankets typically include a fabric embedded into rubber. Transmission belts and other types of belts also contain reinforced rubber with fibers.

Pneumatic springs commonly referred to as air springs, have been used with motor vehicles for a number of years to provide cushioning between movable parts of the vehicle, primarily to absorb shock loads impress on the vehicle axles by the wheels striking an object in the road or falling into a depression. These air springs usually consist of a flexible elastomeric sleeve or bellows containing a supply of compressed air or other fluid and having one or more pistons located within the flexible sleeve to cause compression and expansion as the vehicle experiences the road shocks. The pistons cause compression and expansion within the spring sleeve and since the sleeve is of a flexible material permits the pistons to move axially with respect to each other within the interior of the sleeve. The ends of the sleeve usually are sealingly connected to the pistons or end members and have one or more rolled ends which permit the end members to move axially with respect to each other between a jounce or collapsed position and a rebound or extended position without damaging the flexible sleeve.

It is desirable that a damping mechanism or device be used in combination with such air springs to provide damping for controlling the movement of the air springs. In one embodiment, the rubber reinforced article is used in an air spring. In some embodiment, the rubber reinforced article is used as o a spacer for the piston or bead plate of an air spring assembly.

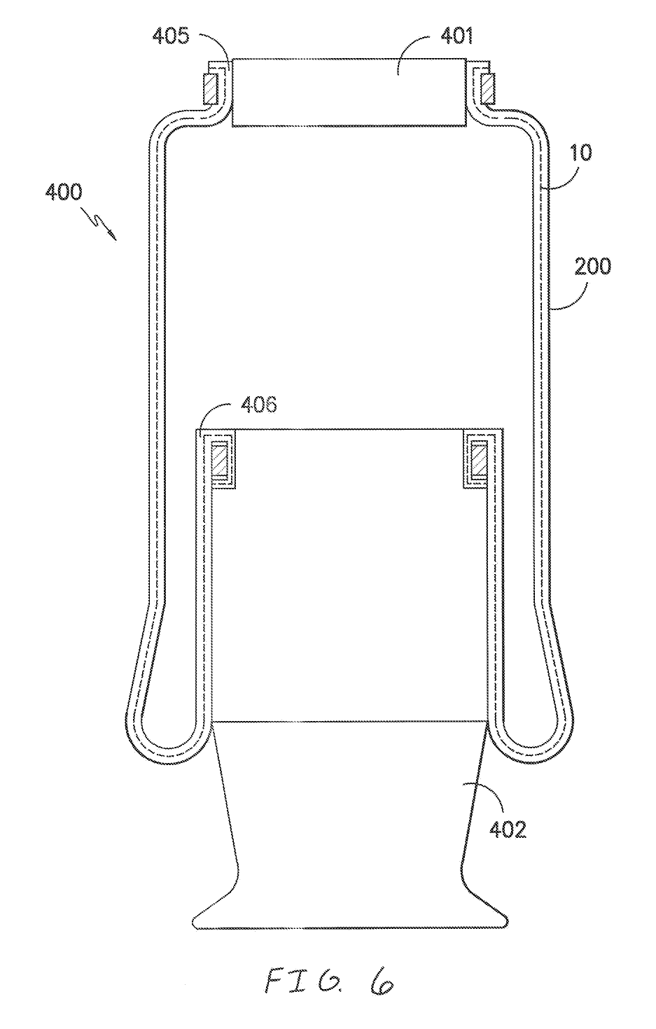

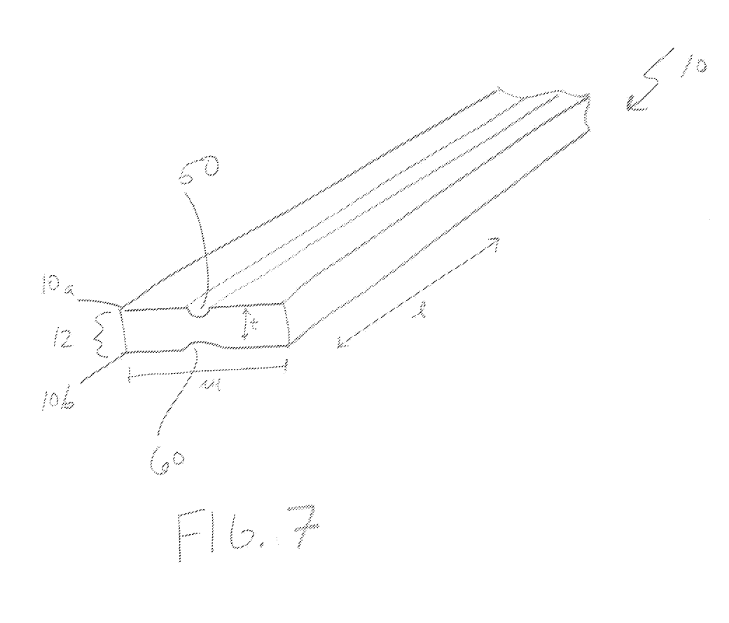

FIG. 6 illustrates schematically the reinforced rubber product 200 being a sleeve in a type of air spring 400. The fibers 10, preferably tape elements 10, are embedded into rubber forming a sleeve 200 which serves to dampen vibrations for cars and other machinery. In FIG. 6, the sleeve 200 has two ends, a top end 405 connected to an end cap 401 and a bottom end 406 connected to a piston 402. While one variation of an air spring 400 is shown, the reinforced rubber product 200 may be used in any air spring configuration. The cross-sections of the fibers being tape elements 10 can be seen in the cut away view of the air spring 400 as the tape elements 10 are oriented in a circumferential direction within the sleeve 403. This circumferential direction of the tape elements imparts stiffness to the structure.

The fibrous layer 100 is formed from fibers 10. The fibers 10 may be any suitable fiber for the end use. “Fiber” used herein is defined as an elongated body. The fiber may have any suitable cross-section such as circular, multi-lobal, square or rectangular (tape), and oval. In one embodiment, the fibers are tape elements 10. The tape elements may have a rectangular or square cross-sectional shape. These tape elements may also be sometimes referred to as ribbons, strips, tapes, tape fibers, and the like.

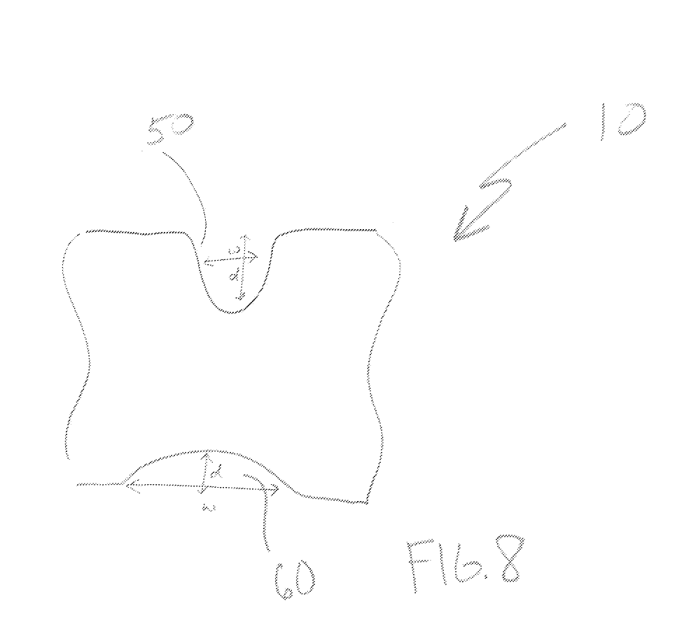

One embodiment of the fiber being a tape element is shown in FIG. 7. In this embodiment, the tape element 10 contains a first layer 12 having an upper surface 10a and a lower surface 10b. The tape element 10 has a thickness “t” defined to be the distance between the upper surface 10a and the lower surface 10b. The tape element 10 also contains a width w and a length I, where the length is at least 100 times the width of the tape element 10, more preferably at least 1000 times the width of the tape element 10. In one embodiment, the tape elements 10 would be considered to be continuous tapes.

In one preferred embodiment, the tape element 10 has a rectangular cross-section. The tape element is considered to have a rectangular or square cross-section even if one or more of the corners of the rectangular/square are slightly rounded or if the opposing sides are not perfectly parallel. Having a rectangular cross-section is preferred for some applications for a variety of reasons. Firstly, the surface available for bonding is greater. Secondly, during a de-bonding event the whole width of the tape is under tension and shear points are significantly reduced or eliminated. In contrast, a multifilament yarn has very little area under tension and there are sections of varying proportions of tension and shear along the circumference of the fiber. In another embodiment, the cross-section of the tape element 10 is a square or approximately square. Having a square cross section could also be preferred in some cases where the width is small and the thickness is high, thereby stacking more tapes in a given width thereby increasing the load carrying capacity of the entire reinforcement element.

In one embodiment, the tape elements 10 have a width of between about 2 and 15 mm, more preferably between about 6 and 15 mm, and more preferably between about 10 and 12.7 mm. In another embodiment, the tape elements have a thickness of between about 0.02 and 2 mm, more preferably between about 0.03 and 0.5 mm, and more preferably between about 0.04 and 0.3 mm. In one embodiment, the tape elements have a width of approximately 13.3 mm and a thickness of approximately 0.2 mm.

The first layer 12 of the fiber 10 comprises a first thermoplastic polymer which may be any suitable orient-able (meaning that the fiber is able to be oriented) thermoplastic. Some suitable thermoplastics for the first layer include polyamides, co-polyamides, polyesters, co-polyesters, polycarbonates, polyimides, and other orient-able thermoplastic polymers. In one embodiment, the first layer contains polyamide, polyester, and/or co-polymers thereof. In one embodiment, the first layer contains a polyamide or polyamide co-polymer. Polyamides are preferred for some applications as it has high strength, high modulus, high temperature retention of properties, and fatigue performance. In another embodiment, the first layer contains a polyester or polyester co-polymer. Polyesters are preferred for some applications as it has high modulus, low shrink and excellent temperature performance.

In one embodiment, the first layer 12 of the tape element 10 is a blend of polyester and nylon 6. The polyester is preferably polyethylene terephthalate. Polyester is employed because of its high modulus and high glass transition temperature which has resulted in the employment of polyester in tire cords and rubber reinforcement cord, primarily due to its flat-spotting resistant nature. Nylon 6 is employed for multiple reasons. It is easier to process than Nylon 6 6. One of the main reasons to incorporate nylon 6 in these embodiments is to function as an adhesion promoter. Nylon 6 has surface groups to which the resorcinol formaldehyde latex can form primary chemical bonds through the resole group. This blend is a physical blend, not a co-polymer and polyester and nylon 6 are immiscible in each other. In one embodiment, powder or pelts of polyester and nylon 6 are simply mixed in the un-melted state to form the blend that will then be feed to an extruder. The extruded tape elements from this physical blend provide good adhesion to rubber and a high modulus.

Preferably, the tape elements 10 are monoaxially oriented meaning that they are oriented in a molten or semi-molten state in primarily one direction. Typically during the monoaxially orienting process, the tape will neck in and lose width.

The tape elements 10 contain at least one crack propagation channel 50 in the upper surface 10a. The crack propagation channel 50 formed is intentional and significantly larger than a crevice or channel formed by a void in a tape at the surface of the tape. The tape elements 10 also contain at least one reciprocal channel 60 in the lower surface 10b of the tape element 10. This reciprocal channel 60 is in registration with the crack propagation channel 50 in the upper surface 10a of the tape element 10. As the channels 50, 60 are reciprocal, the number of crack propagation channels 50 will always equal the number of reciprocal channels 60.

The crack propagation channels 50 and the reciprocal channels 60 extend along the length of the tape element 10 and could be considered continuous along the length of the tape element 10. Preferably, the channels 50, 60 are formed as the tape element is being extruded from an extrusion die.

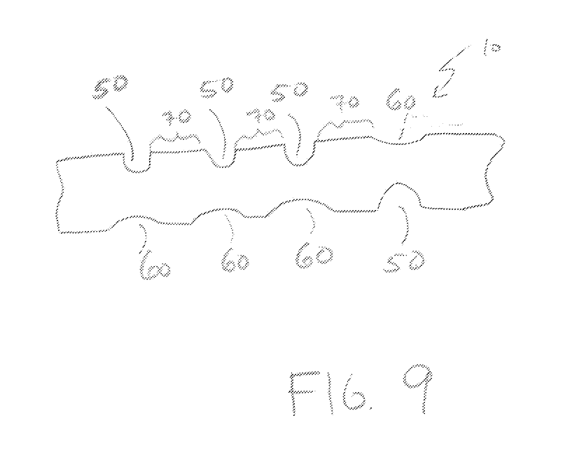

As shown in FIG. 8, the crack propagation channels 50 have a width of the channel and a depth of the channel. Preferably, the aspect ratio of width to depth of the crack propagation channel 50 is between about 1:5 and 10:1, more preferably between about 2:1 and 5:1. The reciprocal channel 60 tends to be a shallower channel as compared to the crack propagation channel 50 and has an aspect ratio of width to depth of between about 1:5 and 30:1, more preferably between about 7:1 and 25:1. In one embodiment, the reciprocal channel 60 has the same aspect ratio and/or depth as the crack propagation channel 50. This structure may be formed when the die contains channel forming features on the upper and lower surfaces of the die in registration. In another embodiment, the reciprocal channel 60 has a great aspect ratio and/or depth as the crack propagation channel.

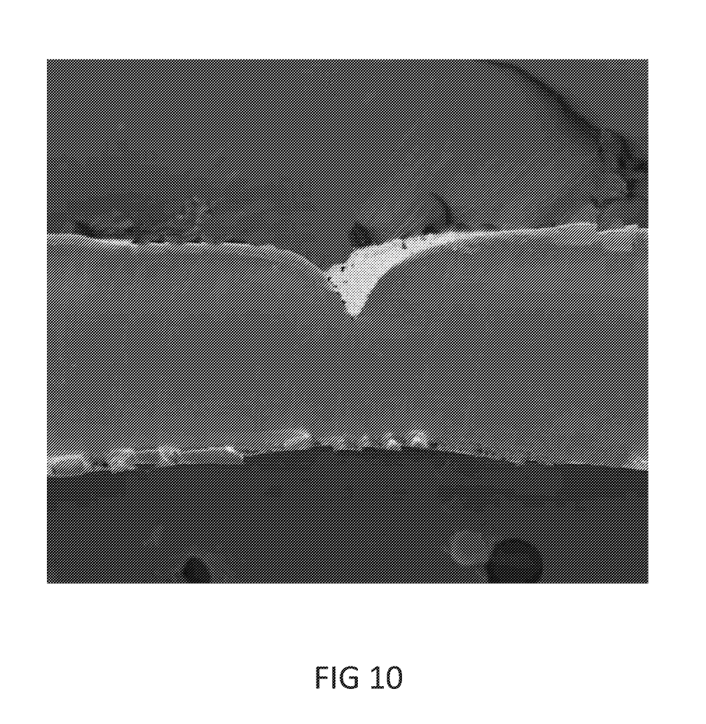

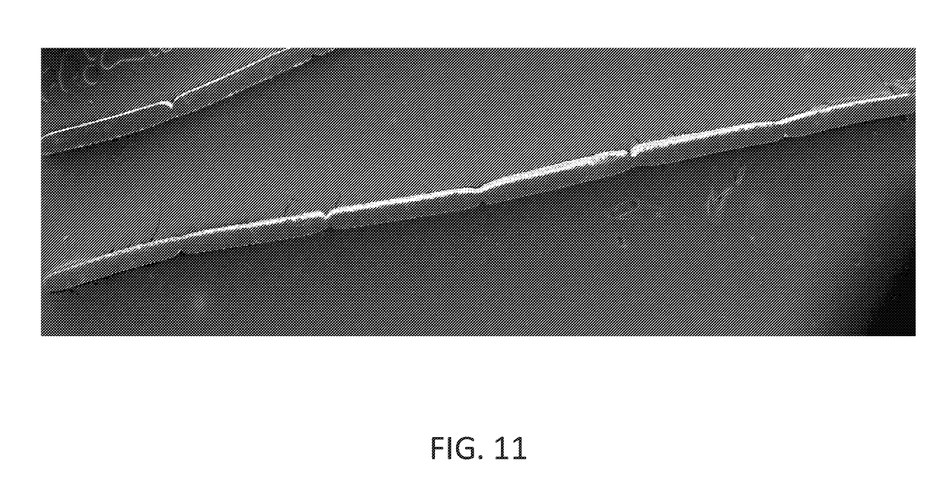

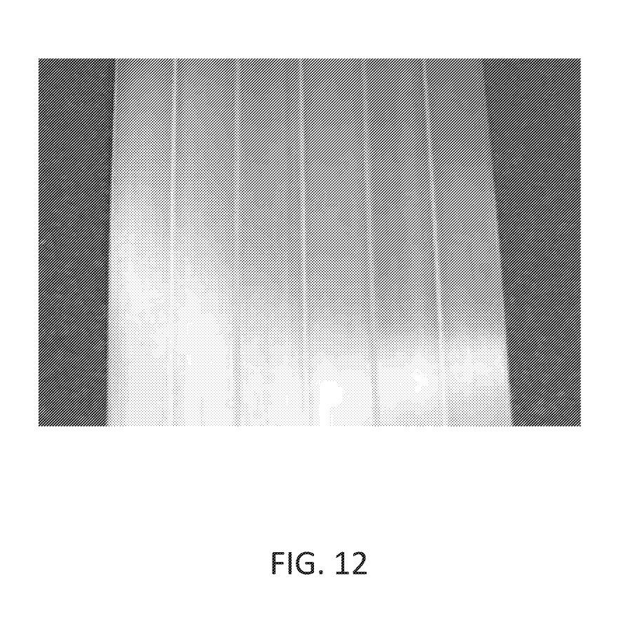

Preferably, the depth of the crack propagation channels 50 is between about 1 and 100% of the thickness of the tape element 10, more preferably between about 20 and 45%. The areas of the tape element along its width that are outside of the channels 50, 60 are defined to be segments 70, such as shown in FIG. 9. Preferably, the thickness of the tape elements 10 within the channel areas 50, 60 are at least about 10% of the thickness of the tape elements in the segment areas. In another embodiment, the thickness of the tape elements 10 within the channel areas 50, 60 are between about 10 and 100% of the thickness of the tape elements in the segment areas, more preferably between about 42 and 60%, more preferably between about 45 and 50%. FIG. 10 is a photomicrograph of a portion of a tape element showing a crack propagation channel and a reciprocal channel. FIG. 11 shows an image of a side view of one embodiment of the tape element and FIG. 12 shows a top view of one embodiment of the tape element. In yet another embodiment where the thickness of one or more of the channels is 100% of the thickness of the tape, the aspect ratio will be defined based on the un-cracked channel width and the full tape thickness.

Preferably, the tape elements 10 comprise between 1 and 10 crack propagation channels 50 (and the same number of reciprocal channels 60), more preferably between 1 and 6, more preferably between 2 and 5. The tape elements 10 will always contain 1 more segment than channel 50. In one embodiment, the crack propagation channels 50 are evenly spaced along the width of the tape elements 10. In another embodiment, the crack propagation channels 50 are unevenly spaced along the width of the tape elements 10. In one embodiment, the width between the crack propagation channels 50 (the segments 70) are between about 1 and 6 mm, more preferably between about 2 and 3 mm.

In one embodiment, at least a portion of one of the crack propagation channels has cracked forming a crack through the entire thickness of the tape element 10. The crack formed may be small (less than an inch), may be larger (between about an inch and a foot), or may be very large (a foot or longer). In one embodiment, at least one of the segments 70 in a tape element is completely separated from the tape element 10. When the crack is very large, the segments 70 of the tape elements 10 separate and may act as tape elements on their own.

In one embodiment, all of the crack propagation channels 50 are in the upper surface 10a of the tape element 10 and all of the corresponding reciprocal channels 60 in the lower surface 10b of the tape element 10. In another embodiment, the upper and lower surfaces 10a, 10b contain crack propagation channels 50 and corresponding reciprocal channels 60. The segmented construction with the channels present in both the upper and the lower surface essentially acts like a two-way hinge and provides the ability to flex both ways in the transverse direction enabling a conforming configuration.

In one embodiment, the tape elements preferably have a draw ratio of at least about 5, a modulus of at least about 2 GPa, and a density of at least about 1.2 g/cm³. In another embodiment, the first layer has a draw ratio of at least about 6. In another embodiment, the first layer has a modulus of at least about 3 GPa or at least about 4 GPa. In another embodiment, the first layer has a density of at least about 1.3 g/cm³ and a modulus of about 9 GPa. A first layer having a high modulus is preferred for better performance in applications such as tire cord, cap-ply, overlay or carcass ply for tires. Lower density for these fibers would be preferred so as to yield a lower weight. Voided fibers would generally tend to have lower densities than their un-voided counterparts.

In one embodiment, the tape elements 10 contains a second layer on the upper surface 10a of the tape element 10 and also may contain an additional third layer on the lower surface 12b of the tape element 10.

The optional second layer and third layer may be formed at the same time as the first layer 12 in a process such as co-extrusion or may be applied after the first layer 12 is formed in a process such as coating. The second layer preferably comprises a second thermoplastic polymer and the third layer preferably comprises a third thermoplastic polymer. The second and third layers preferably contain a polymer of the same class as the polymer of the first layer, but may also contain additional polymers. In one embodiment, the second and/or third layers contain a polymer a block isocyanate polymer. The second and third layers 14, 16 may help adhesion of the fiber to the rubber. Preferably, the melting temperature (Tₘ) of the first layer 12 is greater than the Tₘ of the second layer and third layer.

In one embodiment, the tape elements contain a plurality of voids. “Void” is used herein to mean devoid of added solid and liquid matter, although it is likely the “voids” contain gas. While it has been generally accepted that voided fibers may not have the physical properties needed for use as reinforcement in rubber articles, it has been shown that the voided fibers have some unique benefits. Firstly, presence of voids in the fiber occurs at the cost of the polymer mass. This means that the density of these fibers would be lower than their non-voided counterparts. The volume fraction of the voids would determine the percentage by which the density of this fiber would be lower than the polymer resin. Secondly, the voids act as bladders for an adhesive promoter to be infused into the voided layer/voided fiber, thus providing an anchoring effect. Thirdly, the shape of these voids may control the crack propagation front in an event such as fatigue. The extra surface available for crack propagation would reduce the stress concentration in a cyclic fatigue event involving tensile and/or compressive loading. For the thermoplastic polymers making up the first layer 12 of the tape element 10, the high shear flows during the over-drawing layers to chain orientation and elongation leading to the presence of polymer depleted channels or voids. The voids may be present in any or all of the layers. In addition, the fibrous layer 100 may contain some fibers having no voids and some fibers having voids.

The voids typically have a needle-like shape meaning that the diameter of the cross-section of the void perpendicular to the fiber length is much smaller than the length of the void due to the monoaxially orientation of the fiber. This shape is due to the monoaxially drawn nature of the tape elements 10.

In one embodiment, the voids are in the fiber in an amount of between about 3 and 20% by volume. In another embodiment, the voids are in the fiber in an amount of between about 3 and 18% vol, about 3 and 15% vol, 5 and 18% vol, or about 5 and 10% vol. The density is inversely proportional to the void volume. For example if the void volume is 10%, then the density is reduced by 10%. Since the increase in the voids is typically observed at higher draw ratios (which results in higher strength), the reduction in density leads to an increase in the specific strength and modulus of the fiber which is desired for several applications such as high performance tire reinforcements.

In one embodiment, the size of the voids formed have a diameter in the range of between about 50 and 400 nm, more preferably 100 to 200 nm, and a length of between about 1 and 6 microns, more preferably between about 2 and 3 microns.

The voids in the tape elements may be formed during the monoaxially orientation process with no additional materials, meaning that the voids do not contain any void-initiating particles. The orientation in a fiber bundle is the driving factor for the origin of voids in the fibers. It is believed that slippages between semi-molten materials lead to the formation of voids. The number density of the voids depends on the viscoelasticity of the polymer element. The uniformity of the voids along the transverse width of the oriented fiber depends on whether the complete polymer element has been oriented in the drawing process along the machine direction. It has been observed that in order for the complete polymer element to be oriented in the drawing process, the heat has to be transferred effectively from the heating element (this could be water, air, infra-red, electric and so on) to the polymer fiber. Conventionally, in industrial processes that utilize a hot air convective heating, one feasible way to orient polymer fibers and still maintain industrial speeds is to restrict the polymer fibers in terms of its width and thickness. This means that complete orientation along the machine direction would be achievable more easily when the polymer fibers are extruded from slotted dies or when the polymer is extruded through film dies and then slit into narrow widths before orientation.

In another embodiment, the tape elements contain void-initiating particles. The void-initiating particles may be any suitable particle. The void-initiating particles remain in the finished fiber and the physical properties of the particles are selected in accordance with the desired physical properties of the resultant fiber. When there are void-initiating particles in the first layer 12, the stress to the layer (such as mono-axial orientation) tends to increase or elongate this defect caused by the particle resulting in elongation a void around this defect in the orientation direction. The size of the voids and the ultimate physical properties depend upon the degree and balance of the orientation, temperature and rate of stretching, crystallization kinetics, and the size distribution of the particles. The particles may be inorganic or organic and have any shape such as spherical, platelet, or irregular. In one embodiment, the void-initiating particles are in an amount of between about 2 and 15% wt of the fiber. In another embodiment, the void-initiating particles are in an amount of between about 5 and 10% wt of the fiber. In another embodiment, the void-initiating particles are in an amount of between about 5 and 10% wt of the first layer. In one preferred embodiment, the void-initiating particle is nanoclay.

The fibrous layer 100 containing tape elements 10 may be any suitable fibrous layer such as a knit, woven, non-woven, and unidirectional textile. Preferably, the fibrous layer 100 has an open enough construction to allow subsequent coatings (such as rubber) to pass through the fibrous layer 100 minimizing window pane formation. In another preferred embodiment, the fibrous layer 100 is formed from a single end of tape element 10 continuously wrapped around a rubber article forming a unidirectional fibrous layer. In some embodiments, inducing spacing between the fibers may lead to slight rubber bleeding between the fibers which may be beneficial for adhesion. The fibrous layer 100 of FIG. 1 is a unidirectional fibrous layer 100 where the fibrous layer 100 is embedded into rubber 220 so that all that is shown are the ends of the fibers 10.

In another embodiment, the fibrous layer 100 contains fibers and/or yarns that have a different composition, size, and/or shape to the tape elements 10. These additional fibers may include, but are not limited to: polyamide, aramid (including meta and para forms), rayon, PVA (polyvinyl alcohol), polyester, polyolefin, polyvinyl, nylon (including nylon 6, nylon 6,6, and nylon 4,6), polyethylene naphthalate (PEN), cotton, steel, carbon, fiberglass, steel, polyacrylic, polytrimethylene terephthalate (PTT), polycyclohexane dimethylene terephthalate (PCT), polybutylene terephthalate (PBT), PET modified with polyethylene glycol (PEG), polylactic acid (PLA), polytrimethylene terephthalate, nylons (including nylon 6 and nylon 6,6); regenerated cellulosics (such as rayon or Tencel); elastomeric materials such as spandex; high-performance fibers such as the polyaramids, and polyimides natural fibers such as cotton, linen, ramie, and hemp, proteinaceous materials such as silk, wool, and other animal hairs such as angora, alpaca, and vicuna, fiber reinforced polymers, thermosetting polymers, blends thereof, and mixtures thereof. These additional fibers/yarns may be used, for example, in the warp direction of a woven fibrous layer 100, with the fibers 10 being used in the weft direction.

In one embodiment, the fibers are surrounded at least partially by an adhesion promoter such as an RFL. A frequent problem in making a rubber composite is maintaining good adhesion between the rubber and the fibers and fibrous layers. A conventional method in promoting the adhesion between the rubber and the fibers is to pretreat the yarns with an adhesion layer typically formed from a mixture of rubber latex and a phenol-formaldehyde condensation product wherein the phenol is almost always resorcinol. This is the so called “RFL” (resorcinol-formaldehyde-latex) method. The resorcinol-formaldehyde latex can contain vinyl pyridine latexes, styrene butadiene latexes, waxes, fillers and/or other additives. “Adhesion layer” used herein includes RFL chemistries and other non-RFL rubber adhesive chemistries.

In one embodiment, the adhesion chemistries are not RFL chemistries. In one embodiment, the adhesion chemistries do not contain formaldehyde. In one embodiment the adhesion composition comprises a non-crosslinked resorcinol-formaldehyde and/or resorcinol-furfural condensate (or a phenol-formaldehyde condensate that is soluble in water), a rubber latex, and an aldehyde component such as 2-furfuraldehyde. The composition may be applied to textile substrates and used for improving the adhesion between the treated textile substrates and rubber materials. More information about these chemistries may be found in U.S. application Ser. No. 13/029,293 filed on Feb. 17, 2011, which is incorporated herein in its entirety.

The adhesion layer may be applied to the fibers before formation into a fibrous layer or after the fibrous layer is formed by any conventional method. Preferably, the adhesion layer is a resorcinol formaldehyde latex (RFL) layer or rubber adhesive layer. Generally, the adhesion layer is applied by dipping the fibrous layer or fibers in the adhesion layer solution. The fibrous layer or fibers then pass through squeeze rolls and a drier to remove excess liquid. The adhesion layer is typically cured at a temperature in the range of 150° to 200° C. Preferably, at least one of the surfaces 12a, 12b is covered in a coating comprising an RFL. More preferably, all of the surfaces of the tape elements 10 are covered in an RFL. Preferably, there is a second coating comprising solvated rubber (or other rubber cement coating) on top of and covering the RFL coating.

The adhesion promoter may also be incorporated into a skin layer (the second and/or third layer) of the fiber or may be applied to the fiber and/or fibrous layer is a freestanding film. Thermoplastic films in this category consist of various polyamides and co-polymers thereof, polyolefins and co-polyolefins thereof, polyurethanes and methymethacrylic acid. Examples of these films include 3M™ 845 film, 3M™ NPE-IATD 0693, and Nolax™ A21.2242 film.

The tape elements 10 may be formed in any suitable manner or process. There are two preferred methods for forming the reinforced rubber article. The first preferred method starts by slit extruding polymer to form tape elements. The die typically contains between 1 and 20 slits, each one forming a fiber (tape element), more preferably between 2 and 6 slits. In one embodiment, the each slit die has a width of between about 15 mm and 80 mm and a thickness of between about 0.6 and 2.5 mm. The fibers once extruded are typically 2 to 15 mm wide. The fibers may be extruded having one layer or may have a second layer and/or a third layer using co-extrusion.

The extrusion of the tape elements can be carried out by slitting a profiled slit film extrudate at the desired width or by using a slotted die construction. The resulting extrudate is then drawn via multi-stage operation with or without the use of heat. The protrusions from the die gets transferred to the extrudate, these channels in the extrudate maintain the segment separation proportionate to that in the die through the natural draw process.

In one embodiment a die is used that comprises a die body having a polymer inlet side, a die face, and at least one slot extending through the die body from the inlet side and terminating at the die face at a slot shaped opening. The slot shaped opening has a width and a thickness, wherein the slot comprises an upper surface and a lower surface. The upper surface comprises at least one elongated protrusion at the die face and extending at least 4 mm into the die body. The elongated protrusion has a width and a height and an aspect ratio of width to height between about 1:4 to 2:1. The height of the protrusion is between about 1 and 100% of the thickness of the slot shaped opening preferably between 35 and 50%.

During slit film extrusion or slotted die extrusion, polymer debris can build-up at the lip of the die. The polymer build-up interrupts the flow of the molten polymer coming out from the die face and can create marking on the extrudate surface. Such markings mostly appear only on one surface of the extrudate and are not reproducible in nature and are often discontinuous and random in positioning with the same die arrangement. By creating elongated protrusions that extent into the die, the flow of the polymer melt is guided and the die protrusion shape influences the surface of the polymer melt resulting in channels in the extrudate in a repeatable way. The modification to the flow of the polymer melt due the elongated protrusions also result in a perfectly registered reciprocal channel that is not as sharply pronounced as the die introduced channel.

In one embodiment, the die comprises at least one elongated protrusion. In another embodiment, the die comprises at least 2 elongated protrusions, more preferably at least 3, more preferably at least 4. In one embodiment, the elongated protrusions are evenly spaced across the die and in another embodiment, the elongated protrusions are unevenly spaced across the width of the die. The die can be any type of die including slit, circular, or the link.

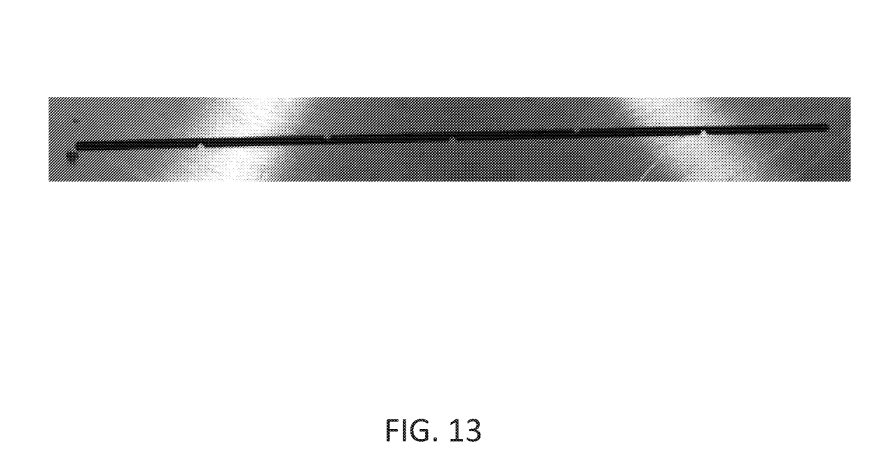

FIG. 13 shows a photograph of one die containing 5 elongated protrusions, two on the upper surface and three on the lower surface. The resultant tape element from this die would contain two crack propagation channels 50 and three reciprocal channels on the upper surface of the tape element 10 and three crack propagation channels 50 and two reciprocal channels on the upper surface of the tape element 10. The crack propagation channels and the reciprocal channels would be in registration. The elongated protrusions are evenly spaced across the width of the die and therefore, the channels in the resultant tape element would also be evenly spaced across the tape element. The tape element formed from this die can be seen in FIG. 12.

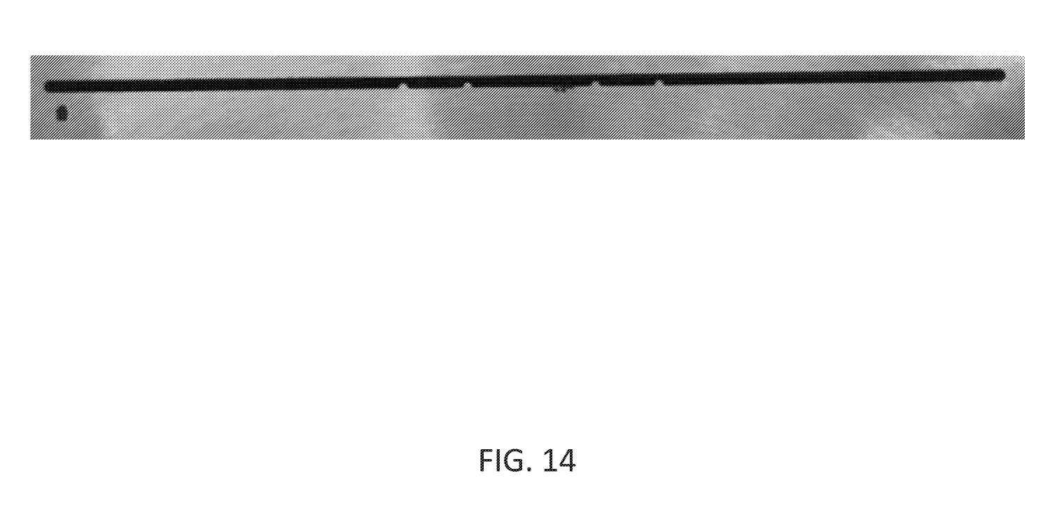

FIG. 14 shows a photograph of one die containing 4 elongated protrusions, all on the lower surface. The resultant tape element from this die would contain four crack propagation channels 50 on the lower surface of the tape element 10 and four reciprocal channels on the upper surface of the tape element 10. The crack propagation channels and the reciprocal channels would be in registration.

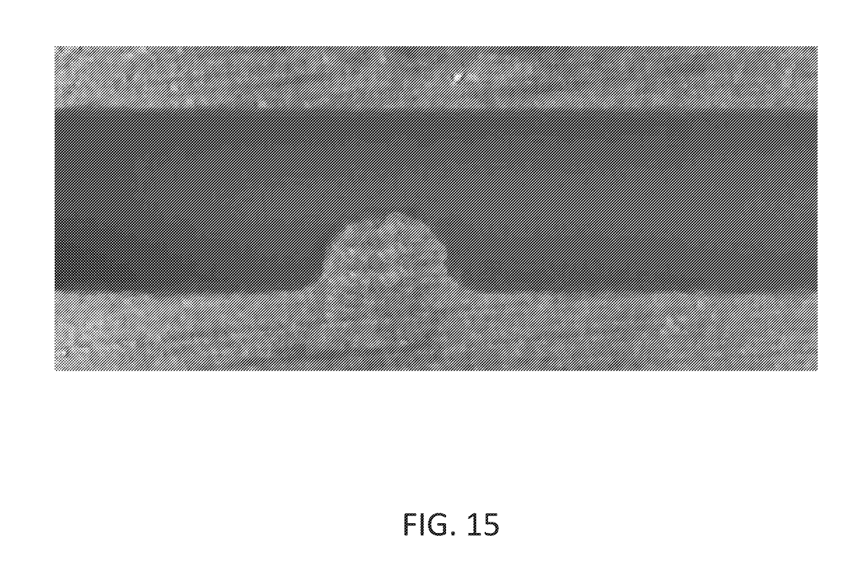

FIG. 15 shows an enlarged cross-sectional view of one elongated protrusion. This view can be used to easily determine the aspect ratio of the elongated protrusion.

Next, the fibers are monoaxially drawn. In one embodiment, the fibers are drawn to a ratio of preferably about 3 or greater (more preferably at least about 4, more preferably at least about 5) resulting in a fiber having a modulus of at least about 2 GPa and a density of at least about 0.85 g/cm³.

Once the fibers are formed, a second and/or third layer may be applied to the fibers in any suitable manner, including but not limited to, lamination, coating, printing, and extrusion coating. This may be done before or after the monoaxial orientation step.

In one embodiment, the drawing of the fibers causes voiding to occur in the fiber. In one embodiment, the voids formed are in an amount of between about 3 and 18% vol. In another embodiment, the extrudant contains polymer and void- initiating particles causing voiding in the fiber and/or crevices on the surface of the fiber to form.

The fibers are formed into a fibrous layer which includes wovens, non-wovens, unidirectionals, and knits. The fibers are then optionally coated with an adhesion promoter such as an RFL coating and at least partially embedded (preferably fully embedded) into rubber. In the embodiments where the fibers contain crevices, it is preferred the adhesion coating at least partially fills the crevices.

In the second method, a polymer is extruded into a film. The film may be extruded having one layer or may have a second layer and/or a third layer using co-extrusion. The die to create a film would have the same properties as the tape element extruder with the elongated protrusions, except that the die would be significantly width and would most likely contain additional elongated protrusions along the width of the die.

Next, the film is slit into a plurality of fibers. In one embodiment, the fibers are tape elements having square or rectangular cross-sectional shapes. These fibers are then monoaxially drawn. In one embodiment, the fibers are drawn to a ratio of preferably about 5 or greater resulting in a fiber having a modulus of at least about 2 GPa and a density of at least about 0.85 g/cm3.

Once the fibers are formed, if a second and/or third layer are desired they may be applied to the fibers in any suitable manner, including but not limited to, lamination, coating, printing, and extrusion coating. This may be done before or after the monoaxial orientation step.

In one embodiment, the drawing of the fibers causes voiding to occur in the fiber. In one embodiment, the voids formed are in an amount of between about 3 and 18% vol. In another embodiment, the extrudant contains polymer and void-initiating particles. When monoaxially oriented, this causes voiding in the fiber and/or crevices on the surface of the fiber to form.

The fibers are formed into a fibrous layer which includes wovens, non-wovens, unidirectionals, and knits. The fibers are then optionally coated with an adhesion promoter such as an RFL coating and at least partially embedded into rubber. In the embodiments where the fibers contain crevices, it is preferred the adhesion coating at least partially fills the crevices.

In another embodiment, the fibers are heat treated before they are formed into the fibrous layer. Heat treatment of fibers offers several advantages such as higher modulus, higher strength, lower elongation and especially lower shrinkage. Methods to heat treat the fibers include hot air convective heat treatment, steam heating, infra-red heating or conductive heating such as stretching over hot plates—all under tension.

### EXAMPLES

The invention will now be described with reference to the following non-limiting examples, in which all parts and percentages are by weight unless otherwise indicated.

### Example 1

Example 1 was a mono-layer segmented Nylon fiber having a rectangular cross-sectional shape with a width of 13 mm and thickness of 0.22 mm. The Nylon used was Nylon 6,6 from Invista as Nylon 6,6 SSP-60D. The polymer was extruded out of a slotted die which had 2 slots with major dimensions of 75 mm by 0.9 mm and having multiple protrusions into the die having dimensions 0.6 mm wide, 0.4 mm high, and extend 12 mm inward from the die face. The protrusions were placed in a staggered fashion with 3 on one side and 2 on the other side of the slotted die surface. The three protrusions were spaced 25 mm apart (center-to-center) on the first side of the slotted die with the middle protrusion centered on the 75 mm slot side. The two protrusions on the second side of the 75 mm slot were placed spatially to align with the middle of the gap between the ones on the first side. The Nylon was extruded at 290° C. at a rate of 31 kg/hr. The resultant segmented tape element was cooled to 32° C. and monoaxially oriented to a draw ratio of between 4.5 and 5. The draw was done in a three stage draw line of 3.8, 1.2, and 1.0 in the first, second and third stages respectively. It is predicted that the same modulus and strength could be attained if the draw ratios were distributed differently. The draw ratios could be further increased to improve the modulus.

The resultant Nylon fiber had channels on its surface that visually seem to separate the Nylon fiber into segments. There were 3 channels on the first surface of the Nylon fiber with less pronounced valley in perfect register on the second surface of the Nylon fiber. There were two channels on the second surface of the Nylon fiber with less pronounced valley in perfect register on the first surface.

### Example 2

Example 2 was a mono-layer segmented Nylon fiber having a rectangular cross-sectional shape with a width of 13 mm and thickness of 0.22 mm. The Nylon used was Nylon 6,6 from Invista as Nylon 6,6 SSP-60D. The polymer was extruded out of a slotted die which had 2 slots with major dimensions of 75 mm by 0.9 mm and having multiple protrusions into the die having dimensions 0.6 mm wide, 0.4 mm high, and extend 12 mm inward from the die face into the die slot. The protrusions were placed on one side of the slotted die surface—4 in number. The 4 protrusions were spaced 5 mm, 10 mm and 5 mm from its immediate neighbor on one side and 27.5 mm from the edge of the 75 mm slot. The Nylon was extruded at 290° C. at a rate of 31 kg/hr. The resultant segmented tape element was cooled to 32° C. and monoaxially oriented to a draw ratio of between 4.5 and 5. The draw was done in a three stage draw line of 3.8, 1.2, and 1.0 in the first, second and third stages respectively. It is predicted that the same modulus and strength could be attained if the draw ratios were distributed differently. The draw ratios could be further increased to improve the modulus. The resultant Nylon fiber had channels on its surface that visually seem to separate the Nylon fiber into segments. There were 4 channels on the first surface of the Nylon fiber with less pronounced valley in perfect register on the second surface of the Nylon fiber.

### Example 3

Example 3 was the resultant Nylon fiber from Example 1 coated with RFL utilizing a resorcinol pre-condensate available from Indspec Chemical Corporation, as Penacolite-2170 and a vinyl-pyridine latex available from Omnova Solutions, as Gentac VP 106 at a (coating weight) of 20% by weight of the dry tapes. The coated tapes were then air-dried and cured in an oven at 220° C. for 30 seconds.

### Example 4

Example 4 was the resultant RFL coated Nylon fiber from Example 3 coated with a 12% solution of a SBR-NR rubber formulation, as available from PTE Polymer Technik Elbe GmbH, solvated in Toluene. The coated tapes were then air-dried and cured in an oven at 90° C. for 30 seconds.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A die comprising a die body having a polymer inlet side, a die face, and at least one slot extending through the die body from the inlet side and terminating at the die face at a slot shaped opening, wherein the slot shaped opening has a width and a thickness, wherein the slot comprises an upper surface and a lower surface, wherein the upper surface comprises at least one elongated protrusion at the die face and extending at least 4 mm into the die body, wherein the elongated protrusion has a width and a height, wherein the aspect ratio of width to height of the protrusions is between about 1:4 and 2:1, and wherein the height of the protrusion is between about 1 and 100% of the thickness of the slot shaped opening.

2. The die of claim 1, wherein the die comprises at least 2 slots.

3. The die of claim 1, wherein the die comprises at least between 2 and 6 slots.

4. The die of claim 1, wherein the upper surface of the slot comprises at least two elongated protrusions.

5. The die of claim 1, wherein the upper surface of the slot comprises at least four elongated protrusions.

6. The die of claim 1, wherein the upper surface of the slot comprises at least two elongated protrusions and the elongated protrusions are evenly spaced along the width of the slot.

7. The die of claim 1, wherein the upper surface and lower surface of the slot each comprise at least one elongated protrusion.

8. The die of claim 1, wherein the slot selected from the group consisting of a slit, a film, and a circular slot.

9. The process of producing a polymer tape comprising, in order:
extruding a molten polymer through a die forming a molten polymer tape, the die comprising a die body having a polymer inlet side, a die face, and at least one slot extending through the die body from the inlet side and terminating at the die face at a slot shaped opening, wherein the slot shaped opening has a width and a thickness, wherein the slot comprises at least one elongated protrusion at the die face and extending at least 4 mm into the die body, wherein the elongated protrusion has a width and a height, wherein the aspect ratio of width to height of the protrusions is between about 1:4 and 2:1, and wherein the height of the protrusion is between about 1 and 100% of the thickness of the slot shaped opening
quenching the molten polymer tape forming a cooled polymer tape;
monoaxially orienting the cooled polymer tape forming an oriented polymer tape, wherein the oriented polymer tape polymer tape having an upper surface and a lower surface, a thickness defined to be the distance between the upper surface and the lower surface, a length, and a width, wherein the length of the tape is at least 100 times larger than the width of the tape, wherein the tape comprises at least a first layer, wherein the first layer comprises a first thermoplastic polymer, wherein the tape comprises at least one crack propagation channel in the upper surface of the tape and at least one reciprocal channel in the lower surface of the tape, wherein the crack propagation channel has an average width and depth, wherein the aspect ratio of width to depth of the channels is between about 1:5 to 10:1, wherein the channels in the upper surface and the lower surface are in registration, wherein the areas between the crack propagation channels are defined as segments, wherein the depth of the crack propagation channel is at least 10% of the thickness of the tape, and wherein the crack propagation channels extend along at least a portion of the length of the tape.

10. The process of claim 9, wherein each elongated protrusion in the slot of the die produces one crack propagation channel and one reciprocal channel.

11. The process of claim 9, wherein the upper surface of the tape element comprises at least two crack propagation channels and the crack propagation channels are evenly spaced along the width of the tape.

12. The process of claim 9, wherein monoaxially orienting the cooled polymer tape is at a draw ratio of at least about 3.

13. The process of claim 9, wherein monoaxially orienting the cooled polymer tape is at a draw ratio of at least about 4.5.

14. The process of claim 9, wherein the thickness of the crack propagation regions is at least 30% less than the thickness of the tape outside of the crack propagation channels.

15. The process of claim 9, wherein the first thermoplastic polymer comprises nylon.

16. The process of claim 9, wherein the first thermoplastic polymer comprises polyester.

17. The process of claim 9, wherein the distance between crack propagation regions along the width of the tape is between about 1 and 6 mm.

18. The process of claim 9, wherein the upper and lower surfaces of the tape element are coated with a first coating comprising an RFL.

19. The process of claim 18, wherein during the coating of the first coating, the tape elements are further oriented.

20. The process of claim 18, wherein the first coating of RFL is followed by coating with a second coating comprising solvated rubber.
